(19) United States
(12) Patent Application Publication
(10) Pub. No.: US 2002/0189298 A1
(43) Pub. Date: Dec. 19, 2002

(54) Apparatus for manufacturing an optical fiber soot, and method for manufacturing an optical fiber soot using the same

(75) Inventors: Kiyoshi Arima, Tokyo (JP); Masahide Kuwabara, Tokyo (JP); Sadayuki Toda, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co, Ltd., Tokyo (JP)

(21) Appl. No.: 09/986,022

(22) Filed: Nov. 7, 2001

(30) Foreign Application Priority Data
Jun. 6, 2001 (JP) 2001-171701

(51) Int. Cl. C03B 37/018

(52) U.S. Cl. 65/531; 65/414

(57) ABSTRACT

An apparatus for manufacturing an optical fiber soot according to a VAD method, in which a cross-section shape of a combustion nozzle of a side burner for heating a core portion is rectangular. A method for manufacturing an optical fiber soot using the apparatus.

### FIELD

The present invention relates to a method for manufacturing an optical fiber soot. The present invention also relates to an apparatus for manufacturing an optical fiber soot.

### BACKGROUND

A vapor-phase axial deposition method (VAD method) comprises a step in which a part of core and clad of an optical fiber (hereinafter referred to as core clad) is synthesized by depositing glass fine-particles, formed in an oxyhydrogen flame, in the axial direction. The deposit synthesized by this method is called core soot. The pulling the resultant soot up in the axial direction is carried out such that the distance between the position of soot tip portion and a core burner is kept constant. The speed for pulling the soot up is called growth speed. An apparatus for use according to this method is schematically illustrated in FIG. 1. A core 1 portion is synthesized by using a core burner 2, and a core clad 3 is synthesized by using a clad burner 4. To heat the core portion and prevent cracking, and to inhibit interference between the flame of the clad burner and the flame of the core burner, a side burner 5 is provided at the middle part between the core portion and the clad portion. The number 6 indicates a bar of starting material for soot deposition, which is generally a solid bar of quartz and which is pulled up in the upward direction 8 (direction of pulling up) while being rotated in the direction (direction of rotation) indicated by an arrow 7. In FIG. 1, V indicates the length of the tapered tip portion of core soot.

The side burner 5, which is conventionally used, has a structure of a multiple-pipe burner 15 having a circular cross section, as shown in FIG. 2. FIG. 2 illustrates the cross section of the conventional burner 5, which has an outer diameter (width) D, and which has an outer pipe, an intermediate pipe, and an inner pipe, indicated by 15a, 15b, and 15c, respectively. Generally, hydrogen gas blows off from the inner pipe, oxygen gas blows off from between the outer pipe and the intermediate pipe, and argon gas blows off from between the intermediate pipe and the inner pipe, so that the combustion flame of the side burner 5 is formed.

To raise the productivity according to the VAD method, it is effective to increase the diameter of the core portion. The increase of the diameter of the core portion proportionally increases the area to be heated by the side burner, in particular the area in the horizontal direction (the area of the cross section having a diameter (diameter of the core to be heated by the side burner) indicated by d in FIG. 1). Therefore, to heat evenly the cross-section portion of the core inside in the horizontal direction, it is necessary to spread the flame.

The flame of a conventional burner can be spread by increasing the amount of gases (combustible gas and combustion-improving gas). However, since the surface temperature of the core portion is raised locally, there are such problems that striae are strengthened to an extent that profile measurement using a profile analyzer (hereinafter abbreviated as PA) becomes impossible, or alternatively, that bubbles are formed in the core preform after making it transparent (sintering). On the other hand, to prevent unevenness of the surface temperature of the core portion, if the diameter of the burner is increased, the flame is spread also in upward and downward directions. Because of this, interference between the flame of the side burner and the flame of the clad burner is increased, and the core soot is deformed in the worst case. To prevent this problem, if the position of the clad burner is shifted upper, the length V of the tapered portion of core soot tip portion becomes larger, and the proportion of defective portions in the resultant core soot increases.

### SUMMARY

The present invention is an apparatus for manufacturing an optical fiber soot according to a vapor-phase axial deposition method, in which a cross-section shape of a combustion nozzle of a side burner for heating a core portion is rectangular.

Further, the present invention is a method for manufacturing an optical fiber soot using the above apparatus for manufacturing an optical fiber soot.

Other and further features and advantages of the invention will appear more fully from the following description, take in connection with the accompanying drawings.

### BRIEF DESCRIPTION OF THE DRAWINGS

FIG. 1 is a view to illustrate the manufacturing of an optical fiber soot according to a VAD method.

FIG. 2 is a cross-sectional view of a conventional multiple-pipe burner for use in a VAD method.

FIG. 3 is a cross-sectional view of a multiple-pipe burner for use in an apparatus of the present invention for manufacturing an optical fiber soot.

FIG. 4 is a graph illustrating the relationship between the diameter D and height H of the burner and the length V of the tapered tip portion.

FIG. 5 is a graph illustrating the relationship between the width L of the burner and the temperature difference ΔT.

FIG. 6 is a view illustrating a cross-section of another example of the multiple-pipe burner for use in an apparatus of the present invention for manufacturing an optical fiber soot.

FIG. 7 is a view illustrating a cross-section of still another example of the multiple-pipe burner for use in an apparatus of the present invention for manufacturing an optical fiber soot.

FIG. 8(a) and FIG. 8(b) illustrate an example of the shape of the tapered tip portion of the side burner, in which FIG. 8(a) is a top view and FIG. 8(b) is a side view.

FIG. 9 is a graph illustrating the relationship between the length h of the hood outlet and the length V of the tapered tip portion.

### DETAILED DESCRIPTION

According to the present invention there are provided the following means:

(1) An apparatus for manufacturing an optical fiber soot according to a VAD method, wherein a cross-section shape of a combustion nozzle of a side burner for heating a core portion is rectangular.

(2) An apparatus for manufacturing an optical fiber soot according to item (1), wherein a width of the rectangular cross-section of the combustion nozzle of the side burner is 0.7 times or more the diameter of the core portion.

(3) An apparatus for manufacturing an optical fiber soot according to item (1) or (2), wherein a length of a tapered portion of the core soot tip portion is controllable, by changing a height H of the rectangular combustion nozzle of the side burner.

(4) An apparatus for manufacturing an optical fiber soot according to item (1), (2), or (3), wherein the rectangular combustion nozzle of the side burner is separated left and right at the center thereof.

(5) An apparatus for manufacturing an optical fiber soot according to item (1), (2), or (3), wherein at least two layers of combustible gas are formed in the side burner.

(6) An apparatus for manufacturing an optical fiber soot according to any one of items (1) to (5), wherein the length of the tapered portion of the core soot tip portion is controllable, by changing the nozzle tip shape (height of taper) of the burner hood to be attached to the burner tip portion of the side burner without changing the burner shape.

(7) A method for manufacturing an optical fiber soot that uses the apparatus for manufacturing an optical fiber soot as described in any one of items (1) to (6).

Referring now to the preferred embodiments illustrated in the drawings, the apparatus for manufacturing an optical fiber soot for use in the present invention will be explained in detail.

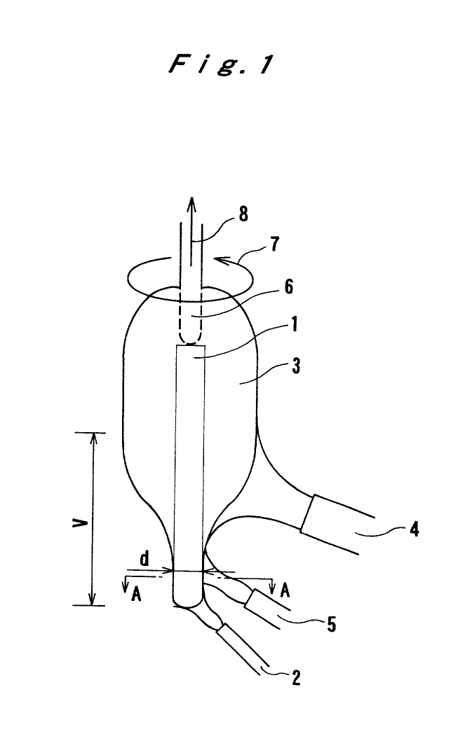

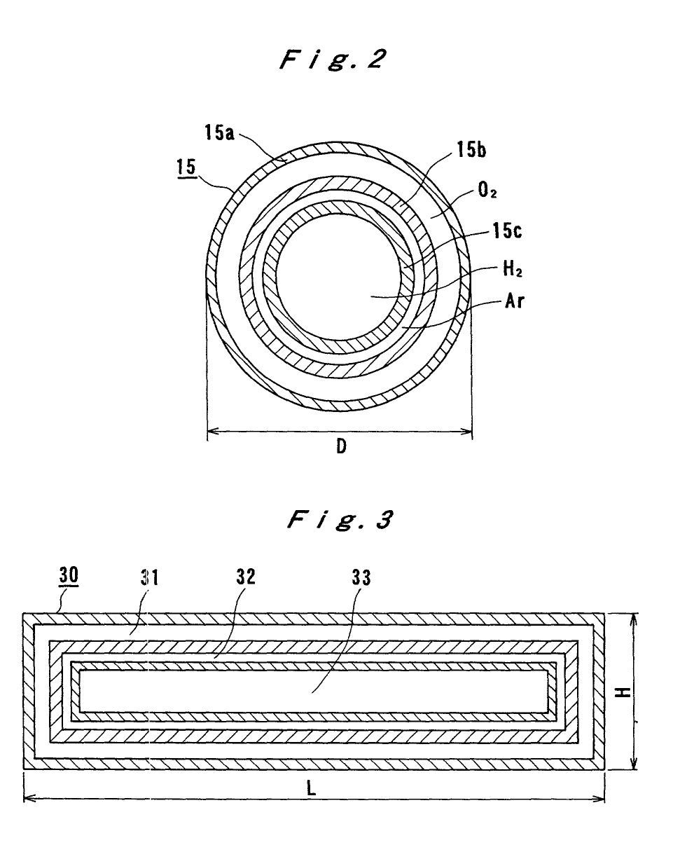

According to the first embodiment of the present invention, in the apparatus for manufacturing an optical fiber soot according to a VAD method, as illustrated in FIG. 1, a rectangular burner as illustrated in FIG. 3 is used as the side burner 5 in place of a conventional multiple-pipe burner having a circular cross-section (FIG. 2). In the cross-sectional view, a rectangular burner 30 has a width of L and a height of H, and composed of, for example, an oxygen gas nozzle 31, an argon gas nozzle 32, and a hydrogen gas nozzle 33.

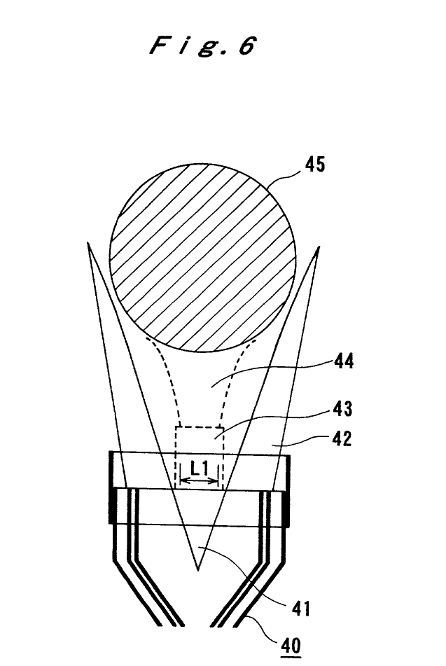

According to another embodiment of the present invention, as shown in FIG. 6, interference between the core burner flame and the side burner flame can be inhibited, by disposing a baffleplate, which separates the gas stream, at the burner center so as to separate the flame left and right. Heretofore, although it has been important to stabilize the core burner flame to secure a stable production in a VAD method, the interference between the side burner flame and the core burner flame constituted one of the destabilizing factors. The interference can be avoided if the side burner is separated from the core burner. However, if the side burner is separated too much from the core burner, cracks are formed on the resultant optical fiber soot. Contrary to the above, in the case of a rectangular burner, since the flame is spread in a horizontal direction so that the periphery of the core portion can be heated, thereby the core section can be sufficiently heated even if a flame is absent in the portion right above the core burner flame.

What is described in the above will be explained referring to FIG. 6 in more detail. FIG. 6 is an illustrative sectional view, taken along line A-A, of the apparatus for manufacturing an optical fiber soot of FIG. 1, and is a view shown in the direction of an arrow A. In FIG. 6, 40 is a rectangular side burner having a cross-sectional shape as illustrated in FIG. 3, and 41 is a baffleplate having a width of L1. 42 is a side burner flame, 43 is a core burner disposed below the side burner, and 44 is a core burner flame. 45 is a cross section of a core to be heated by the side burner and the core burner. The degree of the separation of the flames can be changed by adjusting the width L1 of the baffleplate 41. Heretofore, the fluctuation in the growth speed was about 4 mm/hr, but the fluctuation could be reduced to about 1 mm/hr by using this burner according to one embodiment of the present invention.

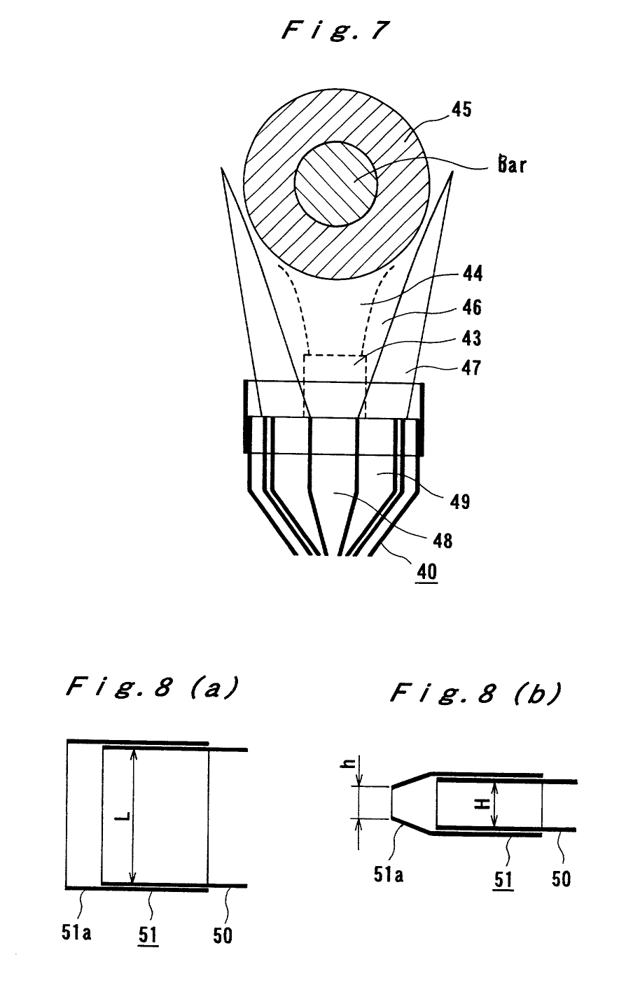

Still another embodiment of the present invention is illustrated in FIG. 7. In the initial stage of core soot formation, it is necessary to maintain the core soot and the surface of the bar of starting material for soot deposition at a high temperature, so as to enhance the adhesion between the core portion and the bar. When using the burner of FIG. 6, since the flame is not in direct contact with the bar of starting material, a relatively large amount of combustible gas and combustion-improving gas is necessary so as to raise the temperature. Therefore, according to an example illustrated in FIG. 7, a layer, which can flow a combustible gas in the center of the burner is provided, so that the temperature of the flame center can be raised. According to this construction, the temperature of the core soot and the bar of starting material for soot deposition can be raised by use of a relatively small amount of gases. Besides, if the diameter of the core portion is increased, the same effect as that of the burner of FIG. 6 can be obtained by reducing the flow rate of the combustible gas in the central layer.

According to this example, the inside of the side burner 40 is separated into a first combustible gas layer 48 at the center, and a second combustible gas layer 49 at the periphery portion. 46 indicates a first layer of the side burner flame, and 47 indicates a second layer of the side burner flame. Similarly in FIG. 6, FIG. 7 is an illustrative sectional view, taken along line A-A, of the apparatus for manufacturing an optical fiber soot of FIG. 1. The reference symbols in FIG. 7 each indicate the same parts or members as in FIG. 6.

FIGS. 8(a) and 8(b) illustrate an example of a shape of the tapered tip portion of the side burner, in which FIG. 8(a) is a top view and FIG. 8(b) is a side view. In FIGS. 8(a) and 8(b), a hood 51 to be attached to the tip portion of a side burner 50 takes the shape of a tapered portion 51a that tapers off toward the tip thereof, so as to reduce the spread of the side burner flame in upward and downward directions. This method can also reduce the spread of the side burner flame in upward and downward directions, and enables shifting lower the position of the clad burner in the apparatus. In the figures, H is a height of the rectangular burner, and h is a height of the tip portion of the tapered portion 51a of the burner hood. Similarly in FIG. 3, L is the width of the rectangular burner.

According to the apparatus and method using the apparatus of the present invention for manufacturing a soot for optical fibers, the proportion of defective portions of the resultant core soot can be reduced in the production process of the soot for optical fibers.

According to the apparatus of the present invention for manufacturing an optical fiber soot, it is possible to heat evenly the core portion surface and prevent occurrence of bubble in a core preform after sintering of the soot. Further, according to the apparatus of the present invention for manufacturing an optical fiber soot, the flame cannot be spread upward and downward even if the burner diameter is increased, and the interference between the flame of the side burner and the flame of the clad burner can be prevented.

The apparatus of the present invention for manufacturing an optical fiber soot exhibits the following functions and effects of the invention.

(1) Since a flame uniform in a horizontal direction can be formed, the surface temperature of the core portion can be controlled approximately uniformly.

(2) The spread of the side burner flame in upward and downward directions can be reduced by narrowing the width of the burner in a vertical direction. Because of this, since the position of the clad burner can be shifted lower in the apparatus, the length V of the tapered portion of core soot tip portion can be shortened.

(3) The interference between the side burner flame and the core burner flame can be reduced, by separating left and right the rectangular combustion nozzle of the side burner at the center of the nozzle. As a result, the core burner flame can be stabilized.

(4) The temperature at the flame center of the side burner can be raised, by forming at least two layers of the combustible gas for the side burner. As a result, the amount of the combustible gas and combustion-improving gas for heating the bar of starting material for soot deposition can be saved.

According to the apparatus of the present invention for manufacturing an optical fiber soot, it is possible to manufacture a high-quality optical fiber soot in an efficient manner.

The present invention will be explained in more detail referring to the following examples, but the invention is not limited thereto.

### EXAMPLES

### Example 1

Core soot production test according to a VAD method with the basic structure, as shown in FIG. 1, was conducted using the burner of FIG. 2 or FIG. 3 as a side burner. In the case of a conventional burner of FIG. 2 (in which the burner outer diameter (width) of D was 0.5d wherein d was a core portion diameter), profile measurement of 9 cores out of 10 cores obtained was impossible by PA because of excessively large striae. Besides, in the cores whose profiles could be measured, bubbles were occurred along the entire length of the obtained core.

On the other hand, in the case where the rectangular burner, as illustrated in FIG. 3, was used, no bubble occurrence was observed and profile measurement could be made, when a multiple-pipe burner having the width enlarged to 0.7d was used.

### Example 2

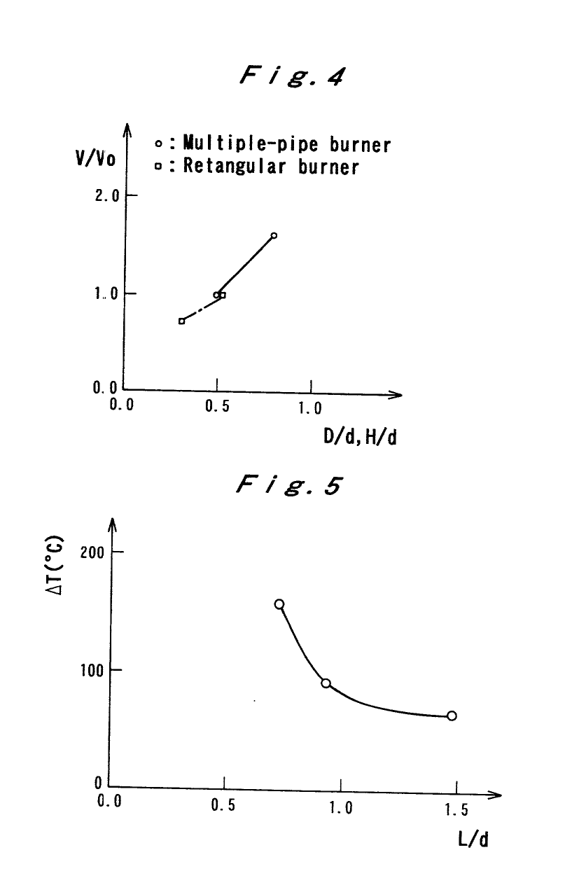

Then, tests were conducted with respect to the length V of the tapered tip portion, as illustrated in FIG. 1. The length of the tapered tip portion of the soot resulting from a conventional burner (see FIG. 2) was defined to be V₀. The length of the tapered tip portion of the soot became longer and was 1.7V₀, when the position of the clad burner was shifted upper using the conventional burner of FIG. 2. Then, the rectangular side burner of FIG. 3 was positioned such that the width having a larger Length was in a horizontal direction and the width L of the burner was fixed to 0.7d. Using the rectangular side burner, synthesis was conducted by changing the height H of the burner according to two levels, i.e., 0.5d and 0.3d. As a result, the lengths of the tapered portion of the resultant soot could be shortened and were V₀ and 0.7V₀, respectively. No bubble formation was observed and profile measurement could be made. This relationship is shown in FIG. 4.

The surface temperature of the core portion while being synthesized was measured. The temperature distribution of the core portion in contact with the flame of the side burner in a peripheral direction was examined. As shown in FIG. 5, the difference ΔT between the maximum temperature and the minimum temperature was about 200° C. in the case of the conventional burner of a circular cross-section, but the difference could be reduced to 100° C. or less in the case of the rectangular burner according to the present invention.

Furthermore, the temperature of the core portion in contact with the flame of the side burner in a peripheral direction was examined with the rectangular burner by varying the width L of the burner. As is apparent from FIG. 5, when the width L became smaller than 0.7d to the diameter of the core portion, the resultant ΔT became abruptly larger. Based on this result, it can be understood that it is preferable that the width L of the rectangular burner is 0.7d or greater to the diameter d of the core portion.

### Example 3

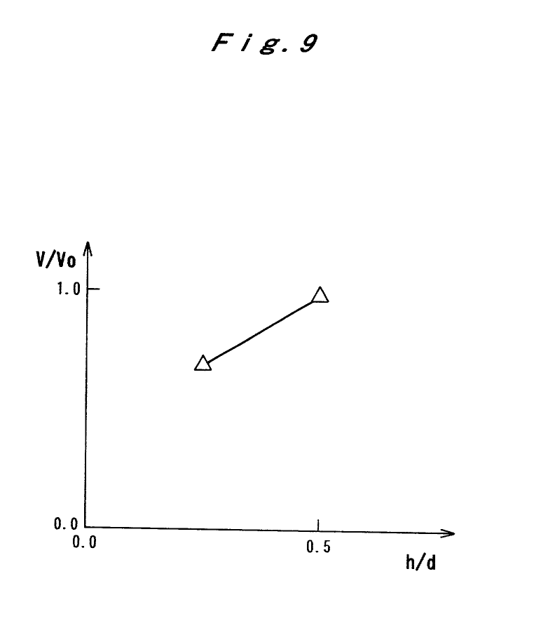

An example in which a burner hood of FIGS. 8(a) and 8(b) was used is described below. FIG. 9 is a graph illustrating the relationship between the height h of the hood and the length V of the tapered portion of the core soot tip portion when the height h was varied while the height H of the burner was unchanged. As is apparent from FIG. 9, the length V of the tapered portion of the core soot tip portion could be reduced by lowering the height of the hood outlet. This method is economical because the length (V) of the tapered portion of the core soot tip portion can be controlled by exchange of the burner hood. Besides, the hood tip portion could be used in a normal state without being burnt, if the height h of the hood outlet was 0.5H or greater, to the height H of the burner.

Having described our invention as related to the present embodiments, it is our intention that the invention not be limited by any of the details of the description, unless otherwise specified, but rather be construed broadly within its spirit and scope as set out in the accompanying claims.

What is claimed is:

1. An apparatus for manufacturing an optical fiber soot according to a vapor-phase axial deposition method, wherein a cross-section shape of a combustion nozzle of a side burner for heating a core portion is rectangular.

2. The manufacturing apparatus according to claim 1, wherein a width of a rectangular cross-section of the combustion nozzle of the side burner is 0.7 times or more the diameter of the core portion.

3. The manufacturing apparatus according to claim 1, wherein a length of a tapered portion of the core soot tip portion is controllable, by changing a height H of the rectangular combustion nozzle of the side burner.

4. The manufacturing apparatus according to claim 1, wherein the rectangular combustion nozzle of the side burner is separated left and right at the center thereof.

5. The manufacturing apparatus according to claim 4, wherein a baffleplate is provided at the center of the rectangular combustion nozzle of the side burner, to separate a flame of the side burner left and right.

6. The manufacturing apparatus according to claim 1, wherein at least two layers of combustible gas are formed in the side burner.

7. The manufacturing apparatus according to claim 1, wherein the length of the tapered portion of the core soot tip portion is controllable, by changing the nozzle tip shape (height of taper) of the burner hood to be attached to the burner tip portion of the side burner without changing the burner shape.

8. The manufacturing apparatus according to claim 7, wherein a height h of a hood outlet of the burner hood to be attached to the burner tip portion of the side burner is 0.5H or greater, to a height H of the burner.

9. A method for manufacturing an optical fiber soot, comprising using an apparatus for manufacturing an optical fiber soot,
wherein, in the apparatus according to a vapor-phase axial deposition method, a cross-section shape of a combustion nozzle of a side burner for heating a core portion is rectangular.

10. The manufacturing method according to claim 9, wherein a width of a rectangular cross-section of the combustion nozzle of the side burner is 0.7 times or more the diameter of the core portion.

11. The manufacturing method according to claim 9, wherein a length of a tapered portion of the core soot tip portion is controllable, by changing a height H of the rectangular combustion nozzle of the side burner.

12. The manufacturing method according to claim 9, wherein the rectangular combustion nozzle of the side burner is separated left and right at the center thereof.

13. The manufacturing method according to claim 9, wherein at least two layers of combustible gas are formed in the side burner.

14. The manufacturing method according to claim 9, wherein the length of the tapered portion of the core soot tip portion is controllable, by changing the nozzle tip shape (height of taper) of the burner hood to be attached to the burner tip portion of the side burner without changing the burner shape.
